(19) United States
(12) Patent Application Publication
(10) Pub. No.: US 2005/0241247 A1
(43) Pub. Date: Nov. 3, 2005

(54) Stair lift system

(76) Inventor: Oscar Sircovich, Jerusalem (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/527,303

(22) PCT Filed: Aug. 31, 2003
(86) PCT No.: PCT/IL03/00714

§ 371 Date: Mar. 8, 2005

(30) Foreign Application Priority Data
Sep. 9, 2002 (IL) 151654

(51) Int. Cl. B66B 21/02

(52) U.S. Cl. 52/183

(57) ABSTRACT

A stairs lift system capable of converting stairs climbing operation into a walking movement along a horizontal plane. The system comprises an existing substrate, flight of stairs, and a second, overlying layer of stairs. Each one of the overlying stairs comprises a lifting element. Mechanical, electronic or hydraulic means are provided for lifting the lifting element up to the height of next-in-line overlaying stair. The lifting means are activated when sensing the presence of a subject having stepped on the first-in-line lifting element. The first-in-line lifting element returns to the initial position once the subject has stepped over to the next-in-line stair; and so forth.

### FIELD OF THE INVENTION

The present invention relates to elevating devices, more particularly to stairs lifting systems.

### BACKGROUND OF THE INVENTION

Stair flights are the most common means for enabling individuals to climb to (or descend from) different levels in residential and other buildings. The most popular alternatives—though much more expensive and not always practicable—are elevators or escalators.

It is the object of the invention to offer an alternative solution, particularly for the elderly or less-fit persons, who live in residential buildings, multi level apartments or family houses, where retrofitting of an elevator is not possible for economic or other reasons.

It is a further object of the invention to provide an array of substitutional stairs readily installable on top of any existing stair flight, converting it into a so to speak “one level walking” elevator.

The closest prior art known to the Applicant are systems specially tailored for the handicapped, i.e. those who need wheelchairs—cf. U.S. Pat. No. 5,802,773.

### SUMMARY OF THE INVENTION

Thus provided according to the present invention is a stairs lift system capable of converting the stairs climbing (or descending) operation into a walking movement along a horizontal plane, the system comprising: an existing substrate flight of stairs, a series of lifting elements, each supported on one of the substrate stairs, thus forming together a second, overlaying layer of stairs, each lifting element comprises: an open top container fitting the length, width and height of a substrate stair, a top panel forming a cover for the container, means for lifting the top panel up to the height of the next-in-line overlaying stair, means for activating the lifting means upon a control command, means for sensing the presence of a subject having stepped on the first-in-line lifting element top panel, means for issuing the control command to the next-in-line lifting element after the subject stepped thereover, and means for lowering the top panel of the first-in-line lifting element to the initial position once the control command has been issued, and so forth with respect to the remaining stairs of the flight.

### BRIEF DESCRIPTION OF THE DRAWINGS

These and additional constructional features and advantages of the invention will become more clearly understood in the light of the ensuing description of a preferred embodiment thereof, given by way of example only with reference to the accompanying drawings, wherein-

FIG. 1 is a schematic representation of a conventional flight of stairs;

FIG. 2 illustrates the principles of the stairs lift system of the present invention;

FIG. 3 is a top view of the stairs lift system of FIG. 2;

FIG. 4 is a cross-sectional view taken along line IV-IV of FIG. 3, illustrating the use of microswitch pad as means for sensing the presence of a subject having stepped over from one to the next lifting element;

FIG. 5 is a schematic cross-sectional view of a lifting element according to a first mechanical version of the system in the withdrawn, inoperative position;

FIG. 6 is a sectional view of the element of FIG. 5 in the extended, operational position;

FIG. 7 is a schematic cross-sectional view of a lifting element according to a second mechanical version of the system in the withdrawn position;

FIG. 8 is a section view of the element of FIG. 7 in the extended position;

FIG. 9 is a sectional view taken along line IX-IX of FIG. 7;

FIG. 10 is a schematic cross-sectional view of a lifting element according to a hydraulic version of the system in the withdrawn position;

FIG. 11 is a sectional view of the element of FIG. 10 in the extended position;

FIG. 12 is similar to FIG. 4 but employing pressure transducer for indicating the passage of the user from one step to the other;

FIG. 13 is a sectional view taken along line XIII-XIII of FIG. 12; and

FIG. 14 is flow chart of the system.

### DETAILED DESCRIPTION OF THE PREFERRED EMBODIMENTS

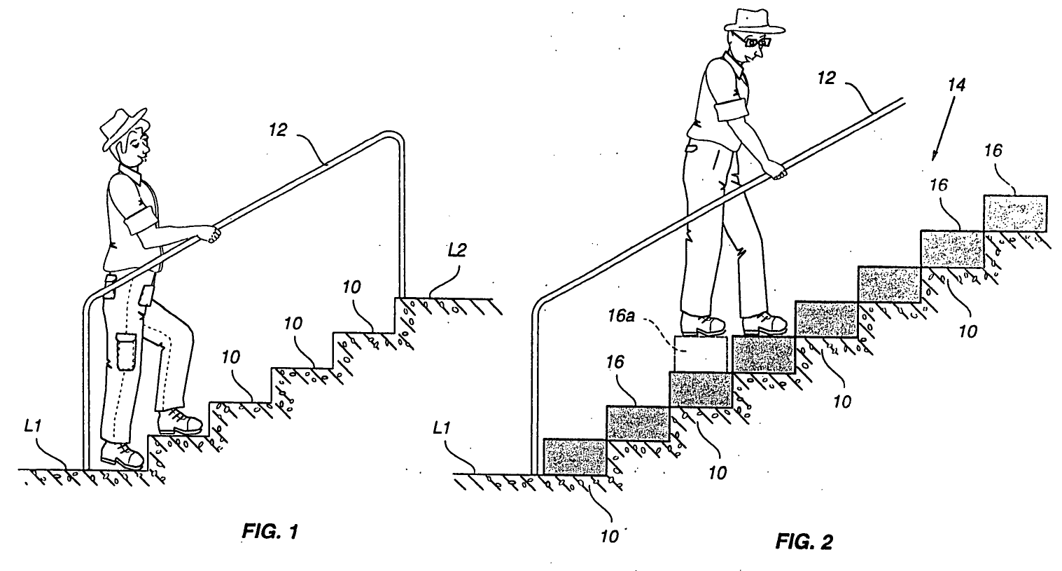

A conventional flight of stairs is illustrated in FIG. 1. Hence, a plurality of stairs 10 are usually laid on a substrate (not shown) between lower level L1 and upper level L2. Typically the height of each stair is 14-21 cm. A handrail 12 is provided for convenience and safety.

The stairs lift system generally designated 14 in FIG. 2 comprises a plurality of lifting elements 16 in the form of crates or boxes following the measurements of and each laid on one of the substrate stairs 10, so that the same pattern of stairs is maintained.

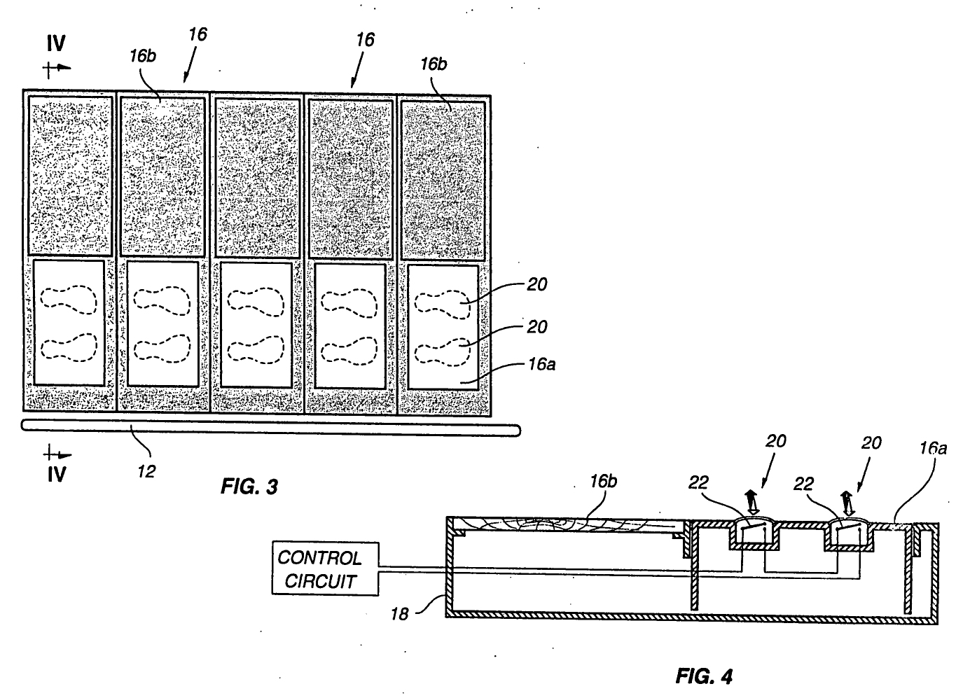

As further seen (FIG. 3), each element 16 comprises a tread portion 16a at the side near the handrail 12, which is adapted, at the proper timing (see below), to become lifted up to the level of the adjacent, higher stair. Hence, a climbing person can simply step over to the next-in-line stair by walking along a horizontal plane, with practically no effort.

In more detail, and as one out of many design options, the lifting element 16 is substantially hollow, and is comprised of an outer casing 18 configured to support at one side a fixed panel 16b.

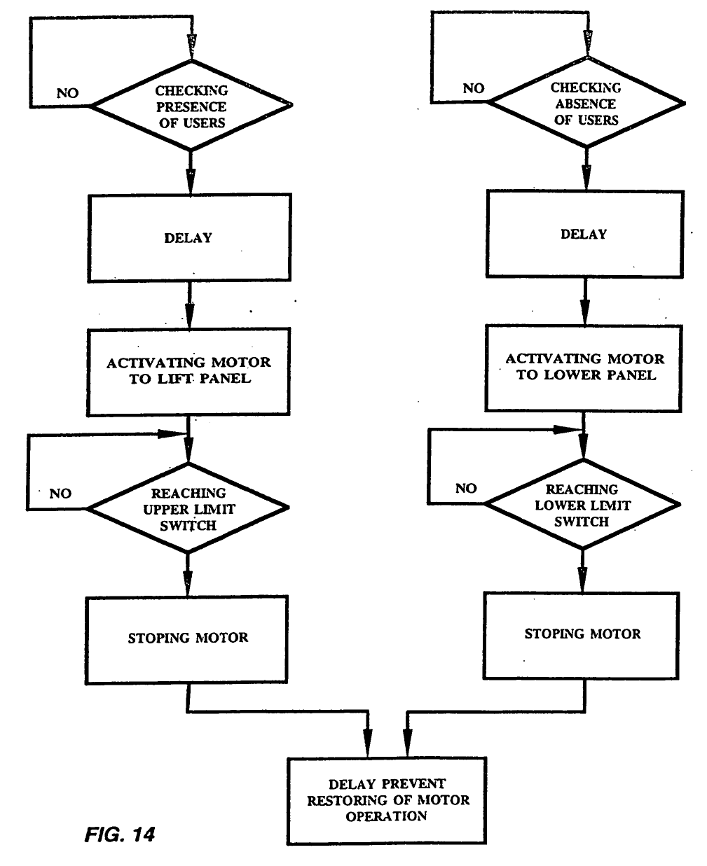

Integrated with the liftable panel 16a are a pair of sensors denoted 20. In the present example, the sensors are foot pads operatively associated with microswitches 22, the arrangement being such that an electric circuit becomes closed (see also FIG. 14) only upon placing thereon both feet of the user. This arrangement is recommended as a measure of safety (see further explanation below).

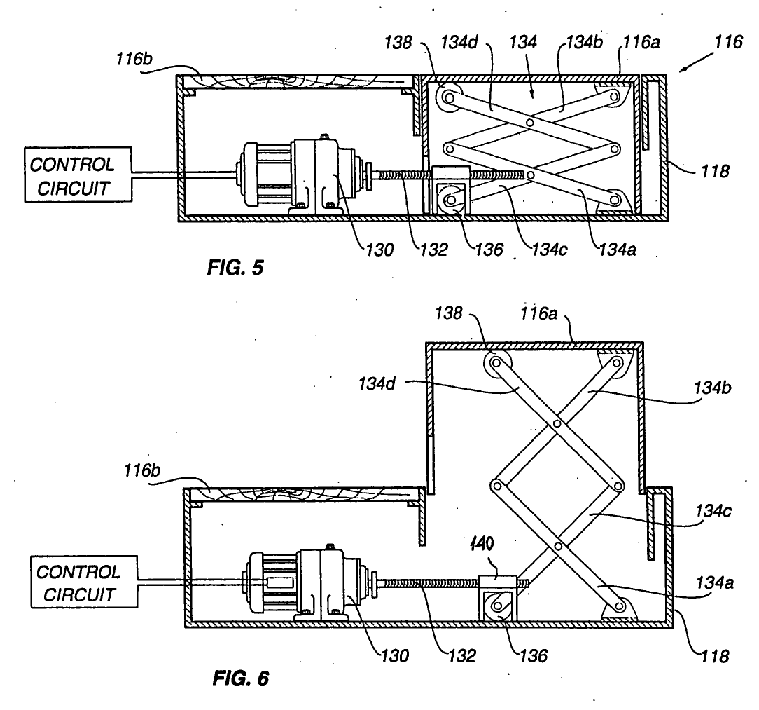

A first, mechanical embodiment of a lifting mechanism will be now described with reference to FIGS. 5 and 6. The left-hand compartment, below the fixed panel 116b conveniently serves a storage for an electric reversible (DC) motor 130. By screw-threaded spindle 132, the motor drives a lazy-tongs mechanism 134 comprising link 134a pivoted at one end to the base 118 and at its other end to link 134b. Link 134b is pivoted to the lifting panel 116a. Links 134c and 134d are pivoted to each other and to the links 134a and 134b as shown, and carry rollers 136 and 138, respectively, the former being installed in a cage 140 which is linearly driven by the spindle 132 by the screw-thread engagement.

The lifting (and lowering) of the panel 116a is clearly depicted in FIG. 6, depending on the running direction of the motor 130.

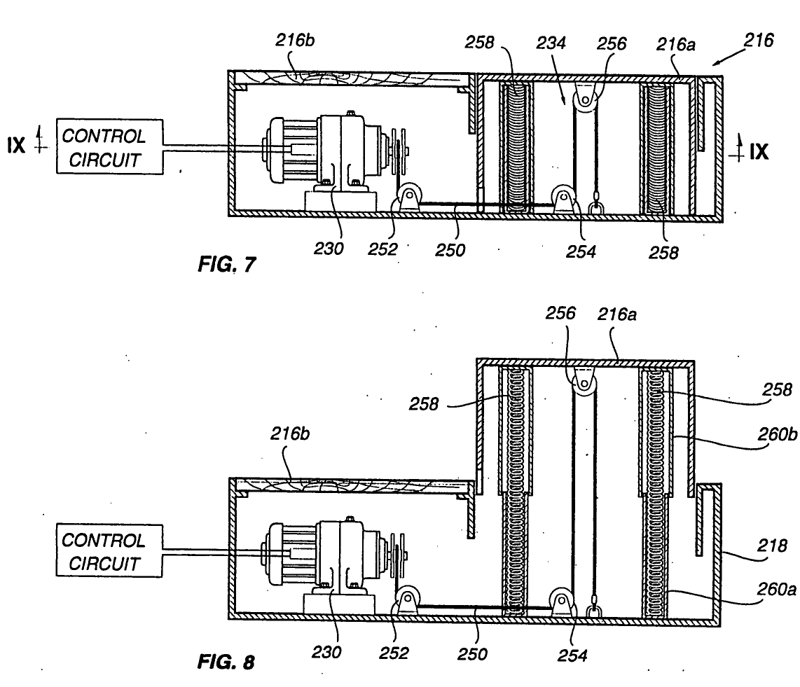

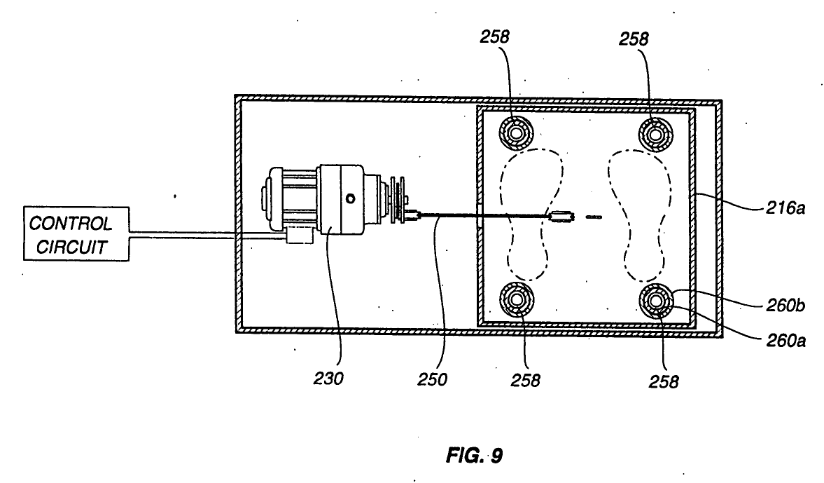

Turning now to FIGS. 7-9, motor 230 is coupled to the lifting panel 216a intermediate a pulley block generally denoted 234. It comprises cable 250 slung over pulleys 252, 254, 256 and anchored against the bottom of the box 218.

The lift panel 216a is constantly urged upwards by four strong coil springs 258, by a force exceeding the maximum allowable weight (say, 100 kg.). The springs are suitably supported by telescopic tubes 260a and 260b.

Provoked by a “lifting” command of the control circuit, the motor will “let go” of the panel 216a which will start to rise under the force of the springs 258. Winding up the cable 250 will pull the panel 216a back to the initial state.

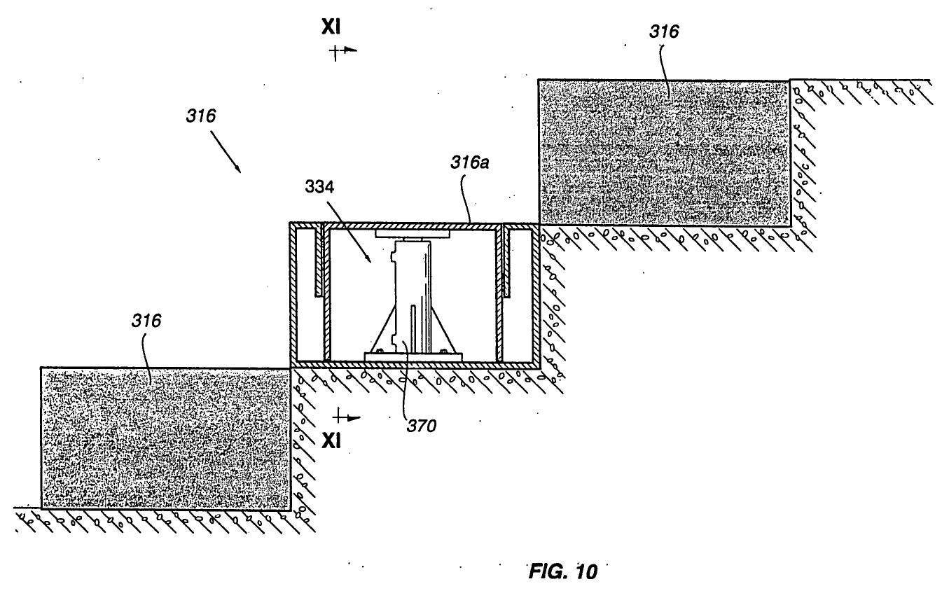

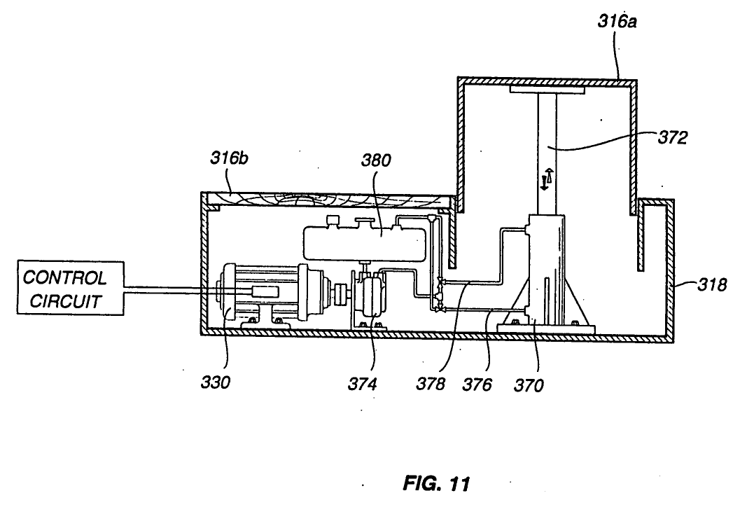

A hydraulic version of the lifting mechanism 334 is illustrated in FIGS. 10 and 11. Hence, a hydraulic jack is used comprising cylinder 370 and piston 372 on which the lift panel 316a is supported.

The motor 330 is coupled to an oil pump 374. The pump 374 is connected by tube 376 to the lower side of the cylinder 370, and by tube 378 to the top side thereof. Oil is supplied from reservoir 380. Suitable check valves are installed as necessary for the lifting and lowering of the piston 372 as known per-se in the art.

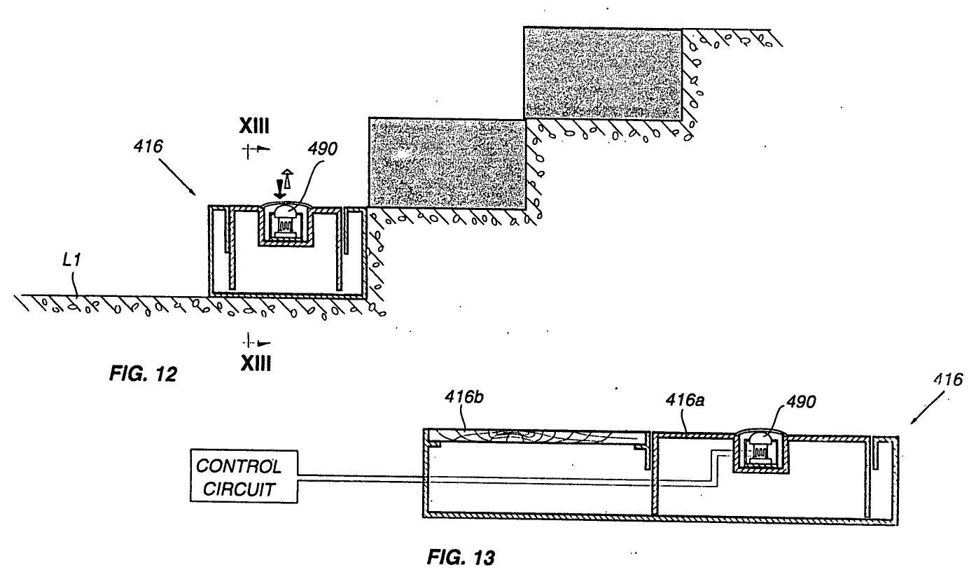

FIGS. 12 and 13 exemplify alternative means for ascertaining that a person has stepped onto the tread panel and is ready to be lifted up to the next stair (instead of using microswitches as described in conjunction with FIG. 4).

As schematically shown, piazoelectric or other known type of press gauges 490 is installed so that in the standby, withdrawn position, a measurement proportional to the weight of a person, standing on the first stair (at level LI) is received and recorded for the following series of stair liftings.

The next lifting will be enabled only after the press-gauge of such next stair indicates that the full weight of the user has in fact been shifted, namely that he left the former lifting element and is ready for the next lifting operation and the withdrawal of the panel behind.

The sequential operation of the stair lift system will be now described with reference to the flow chart of FIG. 14. The chart reflects one full cycle, namely, the lifting and then the lowering of any given tread panel by any one of the operating systems exemplified above.

The left-hand side of the diagram relates to the lifting string of operations. Hence, the control system is in standby position until positively sensing the presence of a subject (both microswitch 22 are closed, or full resting weight applied to press-gauge 490).

After a certain delay, for allowing the user to get ready for lifting, the respective motor is activated to commence the lifting stage.

Once the required level is reached (e.g. sensed by a suitable limit switch associated with the lifting panel or by other suitable means known per-se), the motor is stopped and its operation delayed, either for a given time period or, advantageously for extra safety, until some time after the lifting phase of the next element has started (or even completed!). This would ensure that the user no longer depends in any way on the previously lifted panel, and is fully supported by the next element.

The sequence of stages as above described is now repeated but in the descending direction (see right hand side of the chart).

It has thus been established that the proposed invention offers a neat, relatively low cost solution to the problem at hand as described in the preamble hereto.

Those skilled in the art to which this invention pertains will readily appreciate that numerous changes, variations and modifications can be effectuated without departing from the true spirit and scope of the invention as defined in and by the appended claims.

Thus, for example, the system is readily convertible to be used for descending a flight of stairs, should the need for such use arise.

Another obvious option is to operate the system in a continuous escalator-like fashion.

The system is readily adapted to be applied to non linear flights of stairs such as in curves or of the spiral type.

1. A stairs lift system capable of converting stairs climbing (or descending) operation into a walking movement along a horizontal plane, the system comprising:
An existing substrate flight of stairs; and
a series of lifting elements, each supported on one of the substrate stairs, thus forming together a second, overlying layer of stairs, each lifting element comprises:
an open top container fitting the length, width and height of a substrate stair;
a top panel forming a cover for the container;
means for lifting the top panel up to the height of the next-in-line overlying stair;
means for activating the lifting means upon a control command;
means for sensing the presence of a subject having stepped on the first-in-line lifting element top panel;
means for issuing the control command to the next-in-line lifting element after the subject stepped thereover; and
means for lowering the top panel of the first-in-line lifting element to the initial position once the control command has been issued;
and so forth with respect to the remaining stairs of the flight.

2. The system as claimed in claim 1 wherein the top panel is supported on a mechanical lifting system.

3. The system as claimed in claim 2 wherein the mechanical lifting system comprises an electric motor driving a lazy-tongs system.

4. The system as claimed in claim 2 wherein the mechanical lifting system comprises an electric motor driving a pulley block.

5. The system as claimed in claim 1 wherein the top panel is supported on a hydraulic cylinder and piston assembly operatively coupled to an electrically operated hydraulic pump.

6. The system as claimed in claim 1 wherein the subject presence sensing means comprise at least one microswitch-operating pad.

7. The system as claimed in claim 6 wherein a pair of said pads are installed, one for each foot of the user.

8. The system as claimed in claim 1 wherein the subject presence sensing means comprises a press-gauge device adapted to be activated by the weight of the subject.

9. The system as claimed in claim 8 further comprising means for disabling the issuance of the control command subject to the transition of said weight to the next-in-line lifting element.

10. A method of converting stairs climbing (or descending) operation into a walking movement along a horizontal plane comprising the steps of sequentially lifting a stair occupied by the user to the level of the next-in-line stair, thus enabling the user to walk over to such next-in-line stair, and thereafter lowering the previously occupied stair back to the initial level thereof.

11. The method as claimed in claim 10 further comprising laying a series of stair-like lifting elements over each existing stair and providing each element with lifting and lowering means.

12. The method as claimed in claim 11 wherein the lifting and lowering means comprise an electric motor coupled to a lifting system.

13. The method as claimed in claim 12 wherein the lifting operation of the electric motor is controlled by sensing means installed on a top surface of the lifting element, responsive to the presence of a user thereon, and the lowering operation of the motor is controlled by sensing means associated with the next-in-line lifting element responsive to the presence of a user thereon.

14. The method as claimed in claim 13 wherein the sensing means are activated by the load of the user when stepping on the responsive lifting element.

15. The method as claimed in claim 14 wherein the sensing means comprise a microswitch pad.

16. The method as claimed in claim 13 wherein the sensing means comprise a press-gauge.

17. The method as claimed in claim 12 wherein the lifting system is mechanical.

18. The method as claimed in claim 12 wherein the lifting system is hydraulic.
